(19) United States
(12) Patent Application Publication
(10) Pub. No.: US 2026/0323754 A1
(43) Pub. Date: Oct. 15, 2026

(54) METHODS, DEVICES, AND MEDIUM FOR COMMUNICATION

(71) Applicant: NEC Corporation, Tokyo (JP)

(72) Inventors: Lin LIANG, Beijing (CN); Gang WANG, Beijing (CN)

(73) Assignee: NEC Corporation, Tokyo (JP)

(21) Appl. No.: 19/100,965

(22) PCT Filed: Aug. 5, 2022
(86) PCT No.: PCT/CN2022/110716

§ 371 Date: Feb. 4, 2025

(51) Int. Cl. H04W 76/20; H04B 17/318; H04W 52/36

(52) U.S. Cl. CPC H04W 76/20; H04B 17/328; H04W 52/36

(57) ABSTRACT

Example embodiments of the present disclosure relate to methods, devices, and computer storage medium for communication. A method for communication, comprises: obtaining, at a terminal device from a network device, an offset value for adjusting a first delta preamble value for determining a transmission power for a random access channel, the first delta preamble value being determined based on a format of the random access channel; adjusting the first delta preamble value based on the offset value to obtain a second delta preamble value; determining the transmission power for the random access channel based on the second delta preamble value; and transmitting, to a network device, a random access message on the random access channel using the transmission power.

### FIELD

Example embodiments of the present disclosure generally relate to the field of communication techniques and in particular, to methods, devices, and a computer readable medium for communication.

### BACKGROUND

In 3GPP Release 18 (which is also referred to as “Rel-18”), repetition of Physical Random Access Channel (PRACH) for the same or different beams are introduced to further improve coverage of PRACH.

When transmitting on the PRACH, PRACH transmission power is determined by a target value plus path-loss value. The path-loss value is determined by the terminal device through the measurement of Reference Signal Received Power (RSRP) and configured transmission power. The target value is determined by network configuration and the number of PRACH attempts. It is proposed to further enhance PRACH repetition performance. However, as to how to enhance PRACH repetition performance, it still needs further study.

### SUMMARY

In general, example embodiments of the present disclosure provide methods, devices and a computer storage medium for communication.

In a first aspect, there is provided a method for communication. The method comprises: obtaining, at a terminal device, an offset value for adjusting a first delta preamble value for determining a transmission power for a random access channel, the first delta preamble value being determined based on a format of the random access channel; adjusting the first delta preamble value based on the offset value to obtain a second delta preamble value; determining the transmission power for the random access channel based on the second delta preamble value; and transmitting, to a network device, a random access message on the random access channel using the transmission power.

In a second aspect, there is provided a method for communication. The method comprises: receiving, at a terminal device from a network device, configuration information indicating a first configuration and a second configuration, the first configuration being used for determining a transmission power of a random access channel with repetition, the second configuration being used for determining the transmission power of the random access channel without repetition; and determining the transmission power of the random access channel based on one of the first configuration and the second configuration.

In a third aspect, there is provided a method for communication. The method comprises: transmitting, at a terminal device to a network device, a first transmission on a random access channel using a first transmit beam; and transmitting, to the network device, a second transmission on the random access channel using a second transmit beam different from the first transmit beam, when the terminal device is to monitor a random access response to the first transmission or is monitoring the random access response and when the random access response has not been received.

In a fourth aspect, there is provided a method for communication. The method comprises: determining, at a network device, an offset value for adjusting a first delta preamble value for a terminal device to determine a transmission power for a random access channel, the first delta preamble value being determined based on a format of the random access channel; and transmitting, to the terminal device, information indicating the offset value.

In a fifth aspect, there is provided a method of communication. The method comprises: determining, at a network device, a first configuration and a second configuration, the first configuration being used for a terminal device to determine a transmission power of a random access channel with repetition, the second configuration being used for the terminal device to determine the transmission power of the random access channel without repetition; and transmitting, to the terminal device, configuration information indicating the first configuration and the second configuration.

In a sixth aspect, there is provided a method for communication. The method comprises: receiving, at a network device from a terminal device, a first transmission on a random access channel transmitted using a first transmit beam; and receiving, from the terminal device, a second transmission on the random access channel transmitted using a second transmit beam different from the first transmit beam, when the terminal device is to monitor a random access response to the first transmission or is monitoring the random access response and when the random access response has not been transmitted to the terminal device.

In a seventh aspect, there is provided a terminal device. The terminal device comprises a processor and a memory. The memory is coupled to the processor and stores instructions thereon. The instructions, when executed by the processor, cause the terminal device to perform the method according to any of the first, second and third aspects above.

In an eighth aspect, there is provided a network device. The network device comprises a processor and a memory. The memory is coupled to the processor and stores instructions thereon. The instructions, when executed by the processor, cause the network device to perform the method according to any of the fourth, fifth and sixth aspects above.

In a ninth aspect, there is provided a computer readable medium having instructions stored thereon, the instructions, when executed on at least one processor, causing the at least one processor to carry out the method according to any of the first, second and third aspects or any of the fourth, fifth and sixth aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a signalling chart illustrating communication process in accordance with some embodiments of the present disclosure;

FIG. 3 illustrates another signalling chart illustrating communication process in accordance with some embodiments of the present disclosure;

FIG. 4 illustrates a schematic diagram in accordance with some embodiments of the present disclosure;

FIG. 5 illustrates a flowchart of an example method implemented at a terminal device in accordance with some embodiments of the present disclosure;

FIG. 6 illustrates a flowchart of an example method implemented at a terminal device in accordance with some embodiments of the present disclosure;

FIG. 7 illustrates a flowchart of an example method implemented at a terminal device in accordance with some embodiments of the present disclosure; and

FIG. 8 illustrates a flowchart of an example method implemented at a network device in accordance with some embodiments of the present disclosure;

FIG. 9 illustrates a flowchart of an example method implemented at a network device in accordance with some embodiments of the present disclosure;

FIG. 10 illustrates a flowchart of an example method implemented at a network device in accordance with some embodiments of the present disclosure; and

FIG. 11 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As described above, PRACH transmission power of the terminal device is determined by a target value plus path-loss value. The path-loss value is dependent on the communication path, so it is relatively difficult to improve given a specific path between the terminal device and the network device. Therefore, the target value may be improved in order to enhance the PRACH repetition transmission performance.

The target value is further determined by network configuration and number of PRACH attempts. The target value of PRACH is to set

$$PREAMBLE\_RECEIVED \_TARGET \_POWER = preambleReceivedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA . \qquad ( Equation 1 )$$

As shown above, a delta preamble parameter (i.e., “DELTA_PREAMBLE” in Equation 1) is one of the several factors which may influence the target value. The original value of the delta preamble parameter is based on the preamble format of the PRACH.

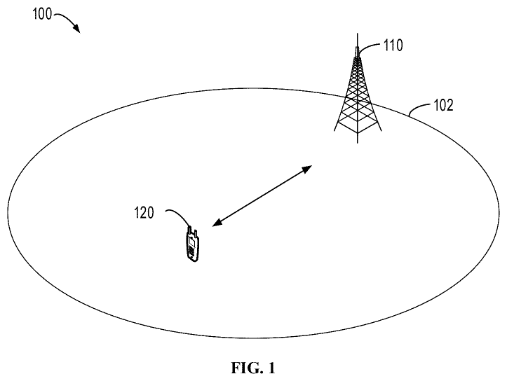

However, in the network environment as illustrated in FIG. 1, even when the terminal device 120 transmits PRACH with its maximum transmission power in one PRACH occasion, the PRACH may not be detected by the network device 110 because, for example, the maximum transmission power of the terminal device 120 has an upper limit, which may be under a threshold below which it cannot be detected by the network device 110. Meanwhile, the terminal device 120 may suffer temporary high interference from a neighbor cell or a neighbor device, which may degrades the PRACH transmission performance and hinder a PRACH with configured target power from being detected by the network device 110. And, when the terminal device 120 transmits PRACH with its maximum transmission power in one PRACH occasion, it may cause interference to a neighbor cell or neighbor device. So there is an issue on how to enhance PRACH repetition in order to enhance cell coverage.

Embodiments of the present disclosure provide a solution of communication. In the solution, methods, devices and medium for PRACH repetition transmission power determination, separate configuration and transmission using different beams without response are provided. As such, the PRACH repetition performance can be enhanced, transmission power can be saved and the communication efficiency may be improved. Principles and implementations of the present disclosure will be described in detail below with reference to the figures.

FIG. 1 illustrates an example communication system 100 in which some embodiments of the present disclosure can be implemented. The communication system 100, which is a part of a communication network, includes a network device 110 and a terminal device 120.

The network device 110 creates a cell 102 for serving the terminal device 120, and can provide services to the terminal device 120, and the network device 110 and the terminal device 120 may communicate data and control information with each other. In some embodiments, the network device 110 and the terminal device 120 may communicate with direct links/channels.

In the system 100, a link from the network devices 110 to the terminal device 120 is referred to as a downlink (DL), while a link from the terminal device 120 to the network devices 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). It is to be understood that the network device 110 may provide one or more serving cells. In some embodiments, the network device 110 can provide multiple cells.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices and their connection relationships and types shown in FIG. 1 are only for the purpose of illustration without suggesting any limitation. The communication system 100 may include any suitable numbers of devices adapted for implementing embodiments of the present disclosure.

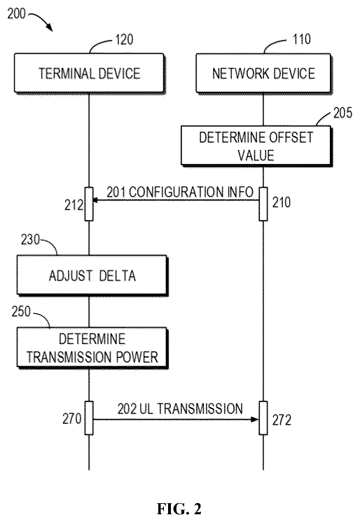

FIG. 2 illustrates a signalling chart illustrating communication process 200 in accordance with some example embodiments of the present disclosure. Only for the purpose of discussion, the process 200 will be described with reference to FIG. 1. The process 200 may involve the terminal device 120 and the network device 110.

The network device 110 may determine 205 an offset value which can be denoted as “s”. The offset value “s” is used for the terminal device 120 to adjust an original delta preamble value (a first delta preamble value) to determine a transmission power for a random access channel. The original delta preamble value is determined based on a format of the random access channel.

The network device 110 transmits 210 configuration information 201 to the terminal device 120. On the other side of communication, the terminal device 120 receives 212 the configuration information 201.

In some example embodiments, the configuration information 201 may be transmitted from the network device 110 to the terminal device 120 via Radio Resource Control (RRC) signaling. The configuration information 201 may comprise the offset value which can be denoted as “s”.

The terminal device 120 may then adjust 230 the original delta preamble value based on the offset value “s” to obtain an adjusted delta preamble value (a second delta preamble value). For example, the terminal device 120 may add the offset value “s” to the original delta preamble value to obtain the adjusted delta preamble in order to determine PRACH transmission power.

TABLE 1
adjust delta preamble

| Preamble | |
|---|---|
| Format | DELTA_PREAMBLE values (dB) |
| 0 | 0 + s |
| A2 | 5 + 3 × μ + s |
| C0 | 11 + 3 × μ + s |

Table 1 shows a schematic example on how to adjust the delta preamble value. As shown in Table 1, the offset value “s” is directly added to the original delta preamble value to obtain the adjusted delta preamble value. It is to be noted that, only 3 rows are listed for illustrative purposes, but all preamble formats should be applicable.

With the adjusted delta preamble value, the terminal device 120 may determine 250 the PRACH transmission power based on the adjusted delta preamble value. With PRACH repetition among multiple occasions while maintaining the same total energy, transmission power in each PRACH occasion can be reduced to below the maximum transmission power.

Then the terminal device 120 may transmit 270 UL transmission 202 with the determined transmission power to the network device 110. On the other side of the communication, the network device 110 may receive 272 the UL transmission 202 from the terminal device 120 and then perform further operations.

In some example embodiments, a PRACH repetition table may be predefined or preconfigured at the terminal device 120, and the configuration information 201 may comprise the number of PRACH repetition.

TABLE 2
PRACH repetition table

| Number of repetition | 1 | 2 | 3 | 4 | 6 | 8 | 12 |
|---|---|---|---|---|---|---|---|
| S values (dB) config. 0 | 0 | −3 | −5 | −6 | −8 | −9 | −11 |
| S values (dB) config. 1 | 0 | 0 | 0 | 0 | 0 | 0 | 0 |

The PRACH repetition table as shown in Table 2 may be predefined or preconfigured at the terminal device 120. As shown in Table 2, the offset value “s” may be determined based on the number of PRACH repetition and configuration 0 or 1 (hereafter also referred to as “config. 0 or 1”). In other words, the terminal device 120 may determine the offset value by looking up in this PRACH repetition table based on the configured number of PRACH repetition and config. 0 or 1. For example, the terminal device 120 may be configured with config. 0. Alternatively, the terminal device 120 may be configured with config. 1, in order to let the network device 110 to accomplish early detection of a PRACH transmission.

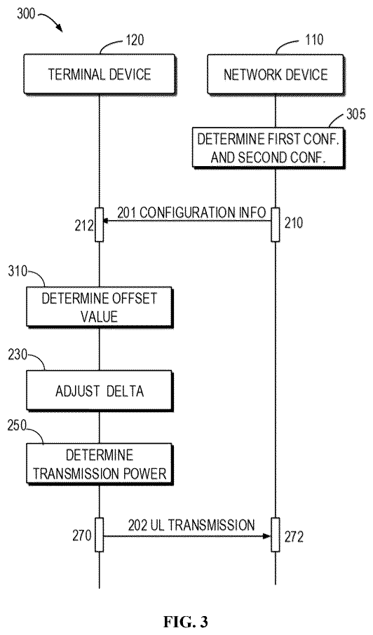

Reference is now made to FIG. 3, which illustrates a signalling chart illustrating communication process 300 in accordance with some embodiments of the present disclosure. Only for the purpose of discussion, the process 300 will be described with reference to FIGS. 1 and 2. The process 300 may involve the terminal device 120 and the network device 110. For the same or alike operations as in process 200, detailed description can be referred to FIG. 2 and thus will be omitted here.

The network device 110 may determine 305 a first configuration and a second configuration. The first configuration is used for the terminal device 120 to determine a transmission power of a random access channel with repetition, and the second configuration is used for the terminal device 120 to determine the transmission power of the random access channel without repetition. Then, the network device 110 transmits 210 configuration information 201 to the terminal device 120, and the configuration information 201 indicates (comprises) the first configuration and the second configuration.

As described above, the offset value “s” is based on the number of PRACH repetition. After the terminal device 120 receives 212 from the network device 110 the configuration information 201 comprising the number of PRACH repetitions, the terminal device 120 may determine 310 the offset value “s” based on a PRACH repetition table (for example, Table 2) and the received number of PRACH repetitions comprised in the configuration information 201.

It is to be noted that, with the PRACH repetition table predefined/preconfigured at the terminal device 120, the offset value “s” may also be directly specified/configured by the network device 110, for example, through a RRC signaling. In this case, the offset value defined in the PRACH repetition table is overridden by the specified/configured by the network device 110. In other words, when the offset value “s” is directly specified/configured by the network device 110, the directly specified/configured offset value “s” (instead of the offset values defined in the PRACH repetition table) is used.

After the offset value “s” is determined, the terminal device 120 may proceed to adjust 230 the delta preamble value. The next operations are already described in connection with FIG. 2, and the description in connection with FIG. 2 can be referred to.

By introducing the offset value “s” to adjust the delta preamble value as well as the transmission power and performing PRACH repetition among multiple occasions while maintaining the same total energy at the terminal device 120, transmission power in each PRACH occasion can be reduced so that the terminal device 120 may transmit UL transmission below its maximum transmission power. Meanwhile, with the offset value “s” which is based on the number of PRACH repetition, the delta preamble value is scaled down by the offset value “s”, and thus the transmission power can also be scaled down by the offset value “s”. In this way, interference to the neighbor cell resulted from the terminal device 120 can be reduced, which is beneficial for the overall system. One the other hand, the network device 110 may detect PRACH before the end of PRACH repetition transmitted by the terminal device 120. Therefore, lower latency could be achieved. So the network device 110 can also configure the offset value “s” as 0 regardless of the repetition number for early detection. Different configuration for the offset value “s” can give more flexibility on the network device 110 to detect PRACH repetition.

In some example embodiments, when the terminal device 110 configures target power for the terminal device 120, the network device 110 may take the number of PRACH repetition into consideration such that the same effect as the offset value “s” as described above could be achieved. Since PRACH repetition demands higher resources than no repetition, it's desirable to reduce the number of PRACH retransmission, i.e. to be detected by the network device 110 as soon as possible in order to reduce the resource load.

For example, the network device 110 may transmit configuration information to the terminal device 120. The configuration information may comprise a first configuration to be used for determining transmission power with PRACH repetition and a second configuration to be used for determining transmission power without PRACH repetition. Then, the terminal device 120, upon receiving such configuration information, may determine the PRACH transmission power based on the configuration information comprising the first configuration and second configuration.

In one example, compared with PRACH without repetition, a separate target power and/or separate power ramping step and/or separate maximum transmission are configured for PRACH repetition. Specifically, the first configuration may comprise at least one of: a first target power, a first power ramping step, or a first maximum transmission, and the second configuration may comprise at least one of: a second target power, a second power ramping step, or a second maximum transmission. In such a case, at least one of the following condition is satisfied: the first target power is different from the second target power, the first power ramping step is different from the second power ramping step, or the first maximum transmission is different from the second maximum transmission.

In another example, the first configuration comprises separate first parameters for transmission on random access channel with repetition, the separate first parameters comprising at least one of: PRACH preambles, occasions, or resources. Specifically, the terminal device 120 may be configured by the network device 110 with a separate/dedicate PRACH preamble, and/or a separate/dedicate occasion, and/or separate/dedicate resources for PRACH repetition. In this way, the network device 110 can easily distinguish PRACH repetition attempts by the terminal device 120 and detect PRACH transmission after non-coherent combination of PRACH occasions.

In another example, the first target power is the same as the second target power for shared random access channel occasions between random access channel with repetition and random access channel without repetition, and the first power ramping step is different from the second power ramping step or the first maximum transmission is different from the Specifically, in shared occasions, power difference second maximum transmission. between PRACH repetition and PRACH non-repetition may cause higher interference, and higher power preamble will cause higher interference to lower power preamble. Therefore, for shared PRACH occasion between PRACH repetition and PRACH non-repetition, the same target power should be configured. In other words, in such a case, the first target power is the same as the second target power. In addition, ramping step and/or maximum transmission for PRACH repetition and PRACH non-repetition could be configured separately/differently.

In this way, a lower number of maximum transmission/retransmission of PRACH repetition and a higher power ramping step of PRACH repetition than the corresponding configurations of no repetition are beneficial.

NR supports a variety of features, e.g. small data transmission, msg3 repetition, reduced capability, etc. To distinguish those features and utilize combination of features, RRC configuration may be used to associate a set of preambles with a feature combination.

PRACH repetition (also referred to as “msg1 repetition”) can also be regarded as a feature and can be combined with other features. For example, combination of features could be a set of preambles associated with combined msg1 repetition and/or msg3 repetition, or could be another set of preambles associated with combined msg1 repetition and/or reduced capability request.

The terminal device 120 can be configured by the network device with different number of PRACH repetitions via RRC signalling. Different number of PRACH repetition can be regarded as different feature. Features with different number of PRACH repetition cannot be combined as combination of features. Therefore, in some example embodiments, the terminal device 120 can be configured with combination of features with the same number of PRACH repetitions, but cannot be configured with features with different number of PRACH repetition, because features with different number of PRACH repetition cannot be combined as combination of features, as stated above.

The network device 110 may configure a first threshold of a beam quality metric for combination of features, and the features may comprise random access channel repetition. Here, the beam quality metric is one of: Layer 1—Reference Signal Received Power (L1-RSRP), Layer 1—Signal to Interference plus Noise Ratio (L1-SINR), RSRP or SINR.

If RSRP is selected as the beam quality metric for combination of features, the terminal device 120 can be configured by the network device 110 with a RSRP threshold via RRC signaling, and the RSRP threshold is used for combination of features that includes PRACH repetition. If the measured actual RSRP (field RSRP) is smaller than the RSRP threshold of combination of features that includes PRACH repetition, the combination of features could be selected as applicable for the terminal device 120. If more than one combination of features with difference on number of PRACH repetition only are selected, combination of features with larger number of PRACH repetition could be selected to be used by the terminal device 120.

In some example embodiments, the terminal device 120 may be configured with separate second parameters in each combination of features comprising random access channel repetition, and the second parameter comprises at least one of: target power, power ramping step, or maximum transmission.

In one example, the terminal device 120 can be configured by the network device 110 with a separate parameter in each combination of features that includes PRACH repetitions. In this case, the separate parameter may comprise at least one of: target power, power ramping step, or maximum transmission. In other words, for each combination of features that includes PRACH repetitions, the network device 110 may configure a separate/different target power and/or a separate/different power ramping step and/or a separate/different maximum transmission.

In some example embodiments, at the terminal device 120, it is notified from Layer 1 (L1) to higher layers to suspend the corresponding power ramping counter when failing to transmit at least one random access channel attempt in a transmission occasion for random access channel repetition comprising multiple random access channel attempts.

In one example, the terminal device 120 fails to transmit all of PRACH attempts in a transmission occasion for PRACH repetition comprising a number of PRACH attempts. In this case, Layer 1 notifies higher layers to suspend the corresponding power ramping counter.

In another example, the terminal device 120 fails to transmit part of a PRACH attempt in a transmission occasion for PRACH repetition comprising a number of PRACH attempts. In this case, Layer 1 may notify higher layers to suspend the corresponding power ramping counter. Alternatively, in this case, Layer 1 also may ignore the failure to transmit part of the PRACH attempt and not notify higher layers to suspend the corresponding power ramping counter (in other words, in this case, Layer 1 may increase the corresponding power ramping counter as usual as though all of the PRACH attempt in the transmission occasion for PRACH repetition has been transmitted successfully).

As to the reason why the terminal device fails to transmit all or part of the PRACH attempts in a transmission occasion for PRACH repetition, it may be due to power allocation to Physical Uplink Share Channel (PUSCH)/Physical Uplink Control Channel (PUCCH)/Physical Random Access Channel (PRACH)/Sounding Reference Signal (SRS) transmissions, or due to power allocation in EUTRA-NR Dual Connectivity (EN-DC) or NR-EUTRA Dual Connectivity (NE-DC) or New Radio-Dual Connectivity (NR-DC) operation, or due to slot format determination, or due to that the PUSCH/PUCCH/PRACH/SRS transmission occasions are in the same slot or the gap between a PRACH transmission and PUSCH/PUCCH/SRS transmission is small.

In some example embodiments, the terminal device 120 transmits at least one of a random access channel attempt with reduced power in a transmission occasion for random access channel repetition comprising multiple random access channel attempts. Then, at the terminal device 120, it is notified from Layer 1 to higher layers to suspend the corresponding power ramping counter.

In one example, due to power allocation to PUSCH/PUCCH/PRACH/SRS transmissions, or due to power allocation in EN-DC or NE-DC or NR-DC operation, the terminal device 120 transmits at least one PRACH attempt with reduced power in a transmission occasion for PRACH repetition comprising a number of PRACH attempts. In this case, at the terminal device 120, Layer 1 may notify higher layers to suspend the corresponding power ramping counter. Alternatively, in this case, Layer 1 also may ignore the fact that at least one PRACH attempt is transmitted with reduced power and not notify higher layers to suspend the corresponding power ramping counter (in other words, in this case, Layer 1 may increment the corresponding power ramping counter as usual as though all of the PRACH attempt in the transmission occasion for PRACH repetition has been transmitted with normal transmission power).

This is because, if the terminal device 120 fails to transmit part of PRACH attempts, or if the terminal device 120 transmits part of PRACH attempts with reduced transmission power, the result is that the network device 110 may accordingly receive lower energy, which is similar to reduced PRACH transmission power from the perspective of the network device 110. So whether to notify the higher layers to suspend the power ramping counter may be determined by the terminal device 120. For example, the terminal device may decide whether to notify the higher layers to suspend the power ramping counter based on the ratio of reduced power. However, if the terminal device 120 fails all repetition attempts (in other words, none of the repetition attempts is transmitted successfully), there is definitely no need to ramp the power in the next time, thus Layer 1 should notify higher layers to suspend the corresponding power ramping counter.

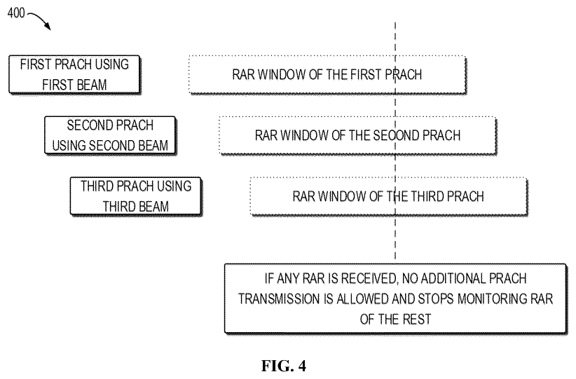

In legacy PRACH transmission, i.e., in PRACH transmission before Rel. 18, the terminal device 120 may re-transmit a PRACH after expiry of RAR (Random Access Response) window. However, in the RAR window, a preamble ID which is used by PRACH may not be detected in the RAR message. The terminal device 120 may change the transmit beam of the retransmission PRACH where power ramping is suspended to determine the transmission power. However, it may cause higher access latency because the terminal device 120 must wait till the end of the RAR window for the next PRACH attempt, especially when beam selected by the first PRACH attempt is not the best one. This issue is addressed below with reference to FIG. 4.

FIG. 4 illustrates a schematic diagram 400 in accordance with some embodiments of the present disclosure. Only for the purpose of discussion, the schematic diagram 400 will be described with reference to FIG. 1. The schematic diagram 400 may involve the terminal device 120 and the network device 110.

In some example embodiments, the terminal device 120 may transmit a first transmission on a random access channel using a first transmit beam to the network device 110. When the terminal device 120 is to monitor a random access response to the first transmission or is monitoring the random access response and when the random access response has not been received, the terminal device 120 may transmit a second transmission on the random access channel using a second transmit beam to the network device 110. The second transmit beam is different from the first transmit beam.

The terminal device 120 does not increase PRACH transmission power of the second transmission. In other words, transmission power is not increased when the terminal device 120 transmits the second transmission using the second transmit beam.

If the network device 110 transmits a RAR to one of the first and second transmission to the terminal device 120, and so the terminal device 120 detects a random access response corresponding to a transmitted random access channel transmission, the terminal device 120 may stop transmitting further random access channel transmission using further beam, and may stop monitoring random access response of other transmitted random access channel transmission. In other words, if any RAR of a transmitted PRACH is detected, the terminal device 120 may stop transmitting PRACH using different beams, and may stop monitoring RAR of other PRACHs which it has transmitted and may stop RACH and transmit message 3 based on the received RAR and corresponding beam.

The first transmit beam and the second transmit beam may have separate counters for preamble power ramping, and the counter for preamble power ramping for a specific beam among the first and second transmit beams is increased by 1 after the specific beam finishes the random access channel transmission. In other words, each beam could have separate PREAMBLE_POWER_RAMPING_COUNTER counters. When retransmission, PREAMBLE_POWER_RAMPING_COUNTER is increase by 1 based on the corresponding counter of a selected transmission beam.

The terminal device 120 may increase counter for preamble power ramping by 1 or N after N random access channel transmission before a random access response is received, and N is the number of beams used to transmit the random access channel transmission to the network device 110. In other words, the terminal device 120 can increase PREAMBLE_TRANSMISSION_COUNTER by 1 or N after N PRACH transmission before a RAR is detected.

In one example illustrated in FIG. 4, the terminal device 120 transmits a first transmission using a first transmit beam to the network device 110. Then the terminal device 120 is going (preparing) to monitor a RAR to the first transmission. Then when the preparation for monitoring the RAR is finished, a RAR window of the first transmission begins, and the terminal device 120 monitors this RAR window for a RAR to the first transmission.

However, unlike in legacy solutions, where the terminal device 120 has to wait till the RAR window ends to start a PRACH retransmission, in the examples illustrated in FIG. 4, the terminal device 120 may start to transmit a second transmission using a second transmit beam well before the RAR window of the first transmission ends, even before the RAR window of the first transmission begins, as illustrated in FIG. 4. In the example illustrated in FIG. 4, when the terminal device 120 is going (preparing) to monitor a random access response to the first transmission and when the random access response has not been received, the terminal device 120 transmits a second transmission using a second transmit beam. Alternatively, the timing the terminal device 120 transmits the second transmission to the network device 110 may also be when the terminal device 120 is monitoring a RAR to the first transmission and when the RAR has not been received. In this example, the second transmit beam is different from the first transmit beam.

The terminal device 120 may start to transmit a third transmission using a third transmit beam well before the RAR window of the second transmission ends, even before the RAR window of the second transmission begins, as illustrated in FIG. 4. In the example illustrated in FIG. 4, when the terminal device 120 is going (preparing) to monitor a RAR to the second transmission and when the RAR has not been received, the terminal device 120 transmits a third transmission using a third transmit beam. Alternatively, the timing the terminal device 120 transmits the third transmission to the network device 110 may also be when the terminal device 120 is monitoring a RAR to the second transmission and when the RAR has not been received. In this example, the third transmit beam is different from the first and second transmit beams.

If any RAR is transmitted by the network device 110 and received by the terminal device 120 before the latest RAR window ends as illustrated in FIG. 4, or in other words, if the terminal device 120 detects any RAR corresponding to a transmitted PRACH transmission, the terminal device 120 may stop transmitting further PRACH transmission using further beam, and may stop monitoring RAR of other transmitted PRACH transmission, and begin the next operation (for example, transmitting a message 3 to the network device 110).

Each of the first, second and third transmit beams may have separate counters for preamble power ramping, and the counter for preamble power ramping for a specific beam among the first, second and third transmit beams is increased by 1 after the specific beam finishes the random access channel transmission. In one example, for the example illustrated in FIG. 4, if no RAR is detected by the terminal device 120 after the three RAR windows end, the first, second and third beam may undergo retransmission. In this case, the counter for preamble power ramping for the first, second and third transmit beam may be increased by 1, respectively. In another example, if no RAR is detected by the terminal device 120 after the first and second RAR windows end, and the third RAR window does not end, the first and second beam may undergo retransmission. In this case, the counter for preamble power ramping for the first and second transmit beam may be increased by 1, respectively, while the counter for preamble power ramping for the third transmit beam remains unchanged.

The terminal device 120 can increase PREAMBLE_TRANSMISSION_COUNTER by 1 or N after N PRACH transmission before a RAR is detected, here N is the number of beams used to transmit the random access channel transmission to the network device 110. In the example as illustrated in FIG. 4, there are three transmit beams, namely the first, second and third transmit beams, so N=3. In one example, for the example illustrated in FIG. 4, if the first, second and third transmit beams have been transmitted successfully, the terminal device 120 can increase PREAMBLE_TRANSMISSION_COUNTER by 1. Alternatively, in this case, the terminal device 120 can increase PREAMBLE_TRANSMISSION_COUNTER by N(=3).

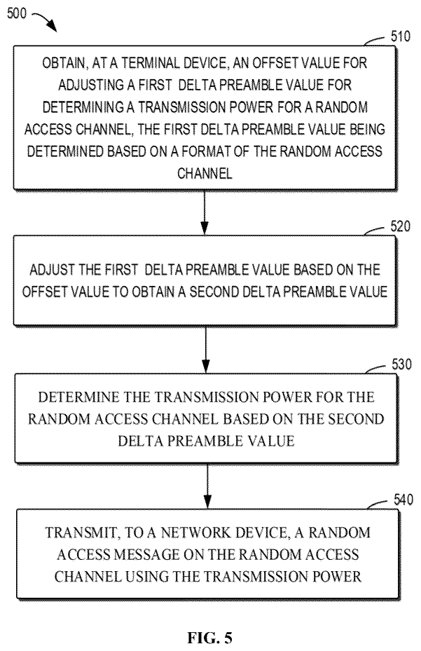

FIG. 5 illustrates a flowchart of an example method 500 implemented at a terminal device in accordance with some embodiments of the present disclosure. For the purpose of discussion, the method 500 will be described from the perspective of the terminal device 120 with reference to FIG. 1.

At block 510, the terminal device 120 obtains, from the network device 110, an offset value for adjusting a first delta preamble value for determining a transmission power for a random access channel. The first delta preamble value is determined based on a format of the random access channel. At block 520, the terminal device 120 adjusts the first delta preamble value based on the offset value to obtain a second delta preamble value. At block 530, the terminal device 120 determines the transmission power for the random access channel based on the second delta preamble value. At block 540, the terminal device 120 transmits, to the network device 110, a random access message on the random access channel using the transmission power.

In some example embodiments, the terminal device 120 receives, from the network device 110, the number of repetitions of a random access channel. The offset value is based on the number of repetitions. In some example embodiments, the offset value is obtained by the terminal device 120 by obtaining the offset value through RRC signaling or by obtaining the offset value from a predefined table based on the number of repetitions. In some example embodiments, the first delta preamble value is adjusted by the terminal device 120 by adding the offset value to the first delta preamble value to obtain the second delta preamble value.

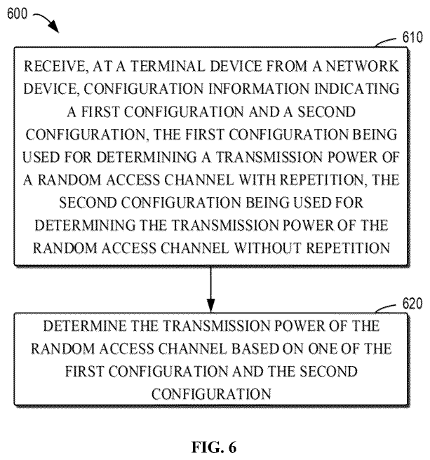

FIG. 6 illustrates a flowchart of an example method 600 implemented at a terminal device in accordance with some embodiments of the present disclosure. For the purpose of discussion, the method 600 will be described from the perspective of the terminal device 120 with reference to FIG. 1.

At block 610, the terminal device 120 receives, from the network device 110, configuration information indicating a first configuration and a second configuration. The first configuration is used for determining a transmission power of a random access channel with repetition, and the second configuration is used for determining the transmission power of the random access channel without repetition. At block 620, the terminal device 120 determines the transmission power of the random access channel based on one of the first configuration and the second configuration.

In some example embodiments, the first configuration comprises at least one of: a first target power, a first power ramping step, or a first maximum transmission, and the second configuration comprises at least one of: a second target power, a second power ramping step, or a second maximum transmission. In this case, at least one of the following condition is satisfied: the first target power is different from the second target power, the first power ramping step is different from the second power ramping step, or the first maximum transmission is different from the second maximum transmission. In some example embodiments, the first configuration comprises separate first parameters for transmission on random access channel with repetition, the separate first parameters comprising at least one of: PRACH preambles, occasions, or resources. In some example embodiments, the first target power is the same as the second target power for shared random access channel occasions between random access channel with repetition and random access channel without repetition.

In some example embodiments, the terminal device 120 is configured by the network device 110 with combination of features with the same number of random access channel repetitions. In some example embodiments, the terminal device 120 is configured by the network device 110 with separate second parameters in each combination of features comprising random access channel repetition, wherein the second parameter comprises at least one of: target power, power ramping step, or maximum transmission.

In some example embodiments, the terminal device 120 notifies from Layer 1 (L1) to higher layers to suspend the corresponding power ramping counter when failing to transmit at least one random access channel attempt in a transmission occasion for random access channel repetition comprising multiple random access channel attempts.

In some example embodiments, the terminal device 120 transmits at least one of a random access channel attempt with reduced power in a transmission occasion for random access channel repetition comprising multiple random access channel attempts, and notifies from Layer 1 (L1) to higher layers to suspend the corresponding power ramping counter.

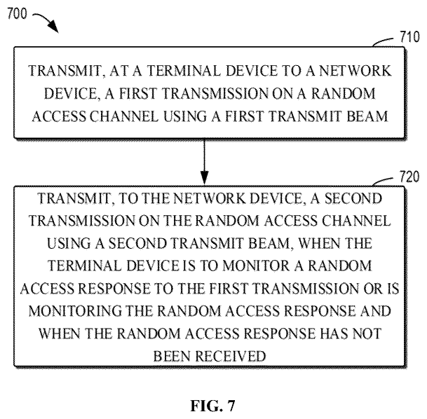

FIG. 7 illustrates a flowchart of an example method 700 implemented at a terminal device in accordance with some embodiments of the present disclosure. For the purpose of discussion, the method 700 will be described from the perspective of the terminal device 120 with reference to FIG. 1.

At block 710, the terminal device 120 transmits, to the network device 110, a first transmission on a random access channel using a first transmit beam. At block 720, the terminal device 120 transmits, to the network device 110, a second transmission on the random access channel using a second transmit beam, when the terminal device is to monitor a random access response to the first transmission or is monitoring the random access response and when the random access response has not been received.

In some example embodiments, transmission power is not increased when transmitting the second PRACH transmission using the second transmit beam. In some example embodiments, the first transmit beam and the second transmit beam have separate counters for preamble power ramping, and the counter for preamble power ramping for a specific beam among the first and second transmit beams is increased by 1 after the specific beam finishes the random access channel transmission.

In some example embodiments, the terminal device 120 increases counter for preamble power ramping by 1 or N after N random access channel transmission before a random access response is received. Here, N denotes the number of beams used to transmit the random access channel transmission to the network device.

In some example embodiments, the terminal device 120 detects a random access response corresponding to a transmitted random access channel transmission; and upon detecting the random access response, the terminal device 120 stops transmitting further random access channel transmission using further beam, and stops monitoring random access response of other transmitted random access channel transmission. In some example embodiments, the terminal device 120 transmits, based on the received random access response and using the corresponding beam, a message 3 to the network device 110.

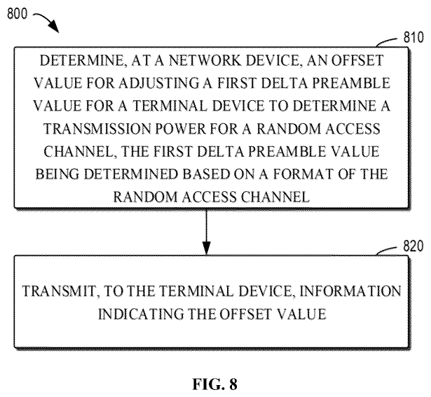

FIG. 8 illustrates a flowchart of an example method 800 implemented at a network device in accordance with some embodiments of the present disclosure. For the purpose of discussion, the method 800 will be described from the perspective of the network device 110 with reference to FIG. 1.

At block 810, the network device 110 determines an offset value for adjusting a first delta preamble value for the terminal device 120 to determine a transmission power for a random access channel, the first delta preamble value being determined based on a format of the random access channel. At block 1220, the network device 110 transmits, to the terminal device 120, information indicating the offset value.

In some example embodiments, the network device 110 transmits, to the terminal device 120, the number of repetitions of a random access channel. The offset value is based on the number of repetitions.

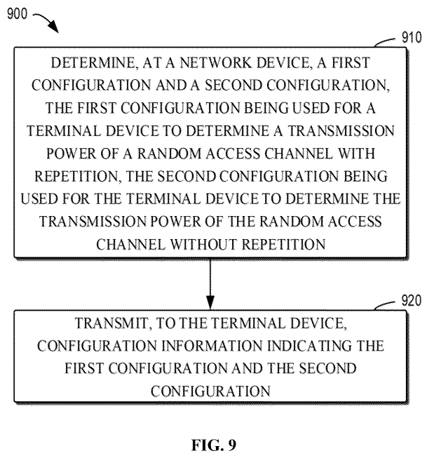

FIG. 9 illustrates a flowchart of an example method 900 implemented at a network device in accordance with some embodiments of the present disclosure. For the purpose of discussion, the method 900 will be described from the perspective of the network device 110 with reference to FIG. 1.

At block 910, the network device 110 determines a first configuration and a second configuration. The first configuration is used for a terminal device to determine a transmission power of a random access channel with repetition, and the second configuration is used for the terminal device to determine the transmission power of the random access channel without repetition. At block 920, the network device 110 transmits, to the terminal device 120, configuration information indicating the first configuration and the second configuration.

In some example embodiments, the first configuration comprises at least one of: a first target power, a first power ramping step, or a first maximum transmission, and the second configuration comprises at least one of: a second target power, a second power ramping step, or a second maximum transmission. In this case, at least one of the following condition is satisfied: the first target power is different from the second target power, the first power ramping step is different from the second power ramping step, or the first maximum transmission is different from the second maximum transmission.

In some example embodiments, the first configuration comprises separate first parameter for transmission with random access channel repetition, the first parameter comprising at least one of: PRACH preamble, occasions, or resources. In some example embodiments, the first target power is the same as the second target power for shared random access channel occasions between random access channel with repetition and random access channel without repetition. In some example embodiments, the network device 110 combines features with the same number of random access channel repetitions as combination of features.

In some example embodiments, the network device 110 configures a first threshold of a beam quality metric for combination of features, the features comprising random access channel repetition.

In some example embodiments, the network device 110 selects a combination of features comprising random access channel repetition upon determination that the received beam quality metric is smaller than a first threshold of the combination of features.

In some example embodiments, the beam quality metric is one of: Layer 1—Reference Signal Received Power (L1-RSRP), Layer 1—Signal to Interference plus Noise Ratio (L1-SINR), RSRP or SINR.

In some example embodiments, the network device 110 configures separate second parameter in each combination of features comprising random access channel repetition, wherein the second parameter comprises at least one of: target power, power ramping step, or maximum transmission.

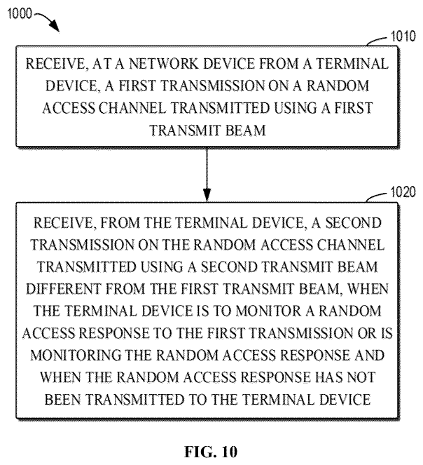

FIG. 10 illustrates a flowchart of an example method 1000 implemented at a network device in accordance with some embodiments of the present disclosure. For the purpose of discussion, the method 1000 will be described from the perspective of the network device 110 with reference to FIG. 1.

At block 1010, the network device 110 receives, from the terminal device 120, a first transmission on a random access channel transmitted using a first transmit beam. At block 1020, the network device 110 receives a second transmission on the random access channel transmitted using a second transmit beam different from the first transmit beam, when the terminal device is to monitor a random access response to the first transmission or is monitoring the random access response and when the random access response has not been transmitted to the terminal device.

In some example embodiments, the network device 110 transmits, to the terminal device 120, a random access response to one of the first transmission and the second transmission.

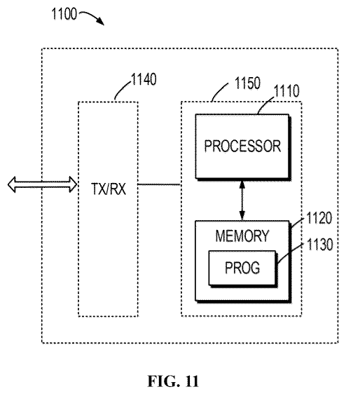

FIG. 11 illustrates a simplified block diagram of a device 1100 that is suitable for implementing embodiments of the present disclosure. The device 1100 can be considered as a further example implementation of the terminal device 120 and/or the network device 110 as shown in FIG. 1. Accordingly, the device 1100 can be implemented at or as at least a part of the terminal device 120 or the network device 110.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 2-10.

The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1550 adapted to implement various embodiments of the present disclosure.

The memory 1120 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In summary, embodiments of the present disclosure may provide the following solutions.

The present disclosure provides a method for communication, comprises: obtaining, at a terminal device from a network device, an offset value for adjusting a first delta preamble value for determining a transmission power for a random access channel, the first delta preamble value being determined based on a format of the random access channel; adjusting the first delta preamble value based on the offset value to obtain a second delta preamble value; determining the transmission power for the random access channel based on the second delta preamble value; and transmitting, to a network device, a random access message on the random access channel using the transmission power.

In one embodiment, the method further comprises: receiving, from the network device, the number of repetitions of a random access channel, wherein the offset value is based on the number of repetitions.

In one embodiment, the method as above, the offset value is obtained by obtaining the offset value through Radio Resource Control (RRC) signaling; or by obtaining the offset value from a predefined table based on the number of repetitions.

In one embodiment, the method as above, the adjusting the first delta preamble value to obtain a second delta preamble value comprises: adding the offset value to the first delta preamble value to obtain the second delta preamble value.

The present disclosure provides a method of communication, comprises: receiving, at a terminal device from a network device, configuration information indicating a first configuration and a second configuration, the first configuration being used for determining a transmission power of a random access channel with repetition, the second configuration being used for determining the transmission power of the random access channel without repetition; and determining the transmission power of the random access channel based on one of the first configuration and the second configuration.

In one embodiment, the method as above, the first configuration comprises at least one of: a first target power, a first power ramping step, or a first maximum transmission; and the second configuration comprises at least one of: a second target power, a second power ramping step, or a second maximum transmission; and at least one of the following condition is satisfied: the first target power is different from the second target power, the first power ramping step is different from the second power ramping step, or the first maximum transmission is different from the second maximum transmission.

In one embodiment, the method as above, the first configuration comprises separate first parameters for transmission on random access channel with repetition, the separate first parameters comprising at least one of: PRACH preambles, occasions, or resources. In one embodiment, the method as above, the first target power is the same as the second target power for shared random access channel occasions between random access channel with repetition and random access channel without repetition.

In one embodiment, the method as above, further comprising: being configured with separate second parameters in each combination of features comprising random access channel repetition, wherein the second parameter comprises at least one of: target power, power ramping step, or maximum transmission.

In one embodiment, the method as above, further comprising: notifying from Layer 1 (L1) to higher layers to suspend the corresponding power ramping counter when failing to transmit at least one random access channel attempt in a transmission occasion for random access channel repetition comprising multiple random access channel attempts.

In one embodiment, the method as above, further comprising: transmitting at least one of a random access channel attempt with reduced power in a transmission occasion for random access channel repetition comprising multiple random access channel attempts; and notifying from Layer 1 (L1) to higher layers to suspend the corresponding power ramping counter.

The present disclosure provides a method of communication, comprises: transmitting, at a terminal device to a network device, a first transmission on a random access channel using a first transmit beam; and transmitting, to the network device, a second transmission on the random access channel using a second transmit beam, when the terminal device is to monitor a random access response to the first transmission or is monitoring the random access response and when the random access response has not been received.

In one embodiment, the method as above, transmission power is not increased when transmitting the second PRACH transmission using the second transmit beam.

In one embodiment, the method as above, the first transmit beam and the second transmit beam have separate counters for preamble power ramping, and the counter for preamble power ramping for a specific beam among the first and second transmit beams is increased by 1 after the specific beam finishes the random access channel transmission.

In one embodiment, the method as above, further comprising: increasing counter for preamble power ramping by 1 or N after N random access channel transmission before a random access response is received, N being the number of beams used to transmit the random access channel transmission to the network device.

In one embodiment, the method as above, further comprising: detecting a random access response corresponding to a transmitted random access channel transmission; and upon detecting the random access response, stopping transmitting further random access channel transmission using further beam, and stopping monitoring random access response of other transmitted random access channel transmission.

In one embodiment, the method as above, further comprising: transmitting, based on the received random access response and using the corresponding beam, a message 3 to the network device.

The present disclosure provides a method of communication, comprises: determining, at a network device, an offset value for adjusting a first delta preamble value for a terminal device to determine a transmission power for a random access channel, the first delta preamble value being determined based on a format of the random access channel; and transmitting, to the terminal device, information indicating the offset value.

In one embodiment, the method as above, further comprising: transmitting, to the terminal device, the number of repetitions of a random access channel, wherein the offset value is based on the number of repetitions.

The present disclosure provides a method of communication, comprises: determining, at a network device, a first configuration and a second configuration, the first configuration being used for a terminal device to determine a transmission power of a random access channel with repetition, the second configuration being used for the terminal device to determine the transmission power of the random access channel without repetition; and transmitting, to the terminal device, configuration information indicating the first configuration and the second configuration.

In one embodiment, the method as above, the first configuration comprises at least one of: a first target power, a first power ramping step, or a first maximum transmission; and the second configuration comprises at least one of: a second target power, a second power ramping step, or a second maximum transmission; and at least one of the following condition is satisfied: the first target power is different from the second target power, the first power ramping step is different from the second power ramping step, or the first maximum transmission is different from the second maximum transmission.

In one embodiment, the method as above, the first configuration comprises separate first parameter for transmission with random access channel repetition, the first parameter comprising at least one of: PRACH preamble, occasions, or resources.

In one embodiment, the method as above, the first target power is the same as the second target power for shared random access channel occasions between random access channel with repetition and random access channel without repetition.

In one embodiment, the method as above, further comprising: combining features with the same number of random access channel repetitions as combination of features.

In one embodiment, the method as above, further comprising: configuring a first threshold of a beam quality metric for combination of features, the features comprising random access channel repetition.

In one embodiment, the method as above, further comprising: selecting a combination of features comprising random access channel repetition upon determination that the received beam quality metric is smaller than a first threshold of the combination of features.

In one embodiment, the method as above, further comprising: selecting a combination of features with a larger number of random access channel repetition among more than one combination of features comprising random access channel repetition.

In one embodiment, the method as above, the beam quality metric is one of: Layer 1—Reference Signal Received Power (L1-RSRP), Layer 1—Signal to Interference plus Noise Ratio (L1-SINR), RSRP or SINR.

In one embodiment, the method as above, further comprising: configuring separate second parameter in each combination of features comprising random access channel repetition, wherein the second parameter comprises at least one of: target power, power ramping step, or maximum transmission.

The present disclosure provides a method for communication, comprises: receiving, at a network device from a terminal device, a first transmission on a random access channel transmitted using a first transmit beam; and receiving, from the terminal device, a second transmission on the random access channel transmitted using a second transmit beam different from the first transmit beam, when the terminal device is to monitor a random access response to the first transmission or is monitoring the random access response and when the random access response has not been transmitted to the terminal device.

In one embodiment, the method as above, further comprising: transmitting, to the terminal device, a random access response to one of the first transmission and the second transmission.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE), the method comprising:
supporting a msg1 repetition which is part of a feature combination in New Radio (NR); and
receiving, from a network, a Radio Resource Control (RRC) configuration, wherein the RRC configuration includes a repetition number for the msg1 repetition, and wherein the RRC configuration includes a Reference Signal Received Power (RSRP) threshold for the msg1 repetition with the repetition number.

22. The method according to claim 21,
wherein the feature combination includes a reduced capability, a small data transmission, a msg3 repetition, and the msg1 repetition.

23. The method according to claim 21, further comprising:
assuming, in a case where an RSRP is less than the RSRP threshold, the msg1 repetition is applicable.

24. The method according to claim 21, further comprising:
supporting msg1 repetitions, wherein Layer 1 notifies a higher layer to suspend a corresponding power ramping counter in a case where the UE does not transmit any of the msg1 repetitions.

25. The method according to claim 21, further comprising:
supporting msg1 repetitions, wherein Layer 1 notifies a higher layer to suspend a corresponding power ramping counter in a case where the UE transmits one or more of the msg1 repetitions.

26. The method according to claim 21, further comprising:
supporting msg1 repetitions, wherein Layer 1 notifies a higher layer to suspend a corresponding power ramping counter in a case where the UE transmits part of the msg1 repetitions.

27. A method of a network device, the method comprising:
supporting a msg1 repetition which is part of a feature combination in New Radio (NR); and
sending, to a User Equipment (UE), a Radio Resource Control (RRC) configuration, wherein the RRC configuration includes a repetition number for the msg1 repetition, and wherein the RRC configuration includes a Reference Signal Received Power (RSRP) threshold for the msg1 repetition with the repetition number.

28. The method according to claim 27,
wherein the feature combination includes a reduced capability, a small data transmission, a msg3 repetition, and the msg1 repetition.

29. A User Equipment (UE) comprising:
a memory; and
a processor coupled with the memory, wherein the processor is configured to:
support a msg1 repetition which is part of a feature combination in New Radio (NR), and
receive, from a network, a Radio Resource Control (RRC) configuration, wherein the RRC configuration includes a repetition number for the msg1 repetition, and wherein the RRC configuration includes a Reference Signal Received Power (RSRP) threshold for the msg1 repetition with the repetition number.

30. A network device comprising:
a memory; and
a processor coupled with the memory, wherein the processor is configured to:
support a msg1 repetition which is part of a feature combination in New Radio (NR), and
send, to a User Equipment (UE), a Radio Resource Control (RRC) configuration, wherein the RRC configuration includes a repetition number for the msg1 repetition, and wherein the RRC configuration includes a Reference Signal Received Power (RSRP) threshold for the msg1 repetition with the repetition number.
